(19) United States
(12) Patent Application Publication
(10) Pub. No.: US 2014/0300079 A1
(43) Pub. Date: Oct. 9, 2014

(54) ATTACHMENT DEVICE AND METHOD OF USE THEREOF

(71) Applicant: Malcolm Rhodes, Heddersfield (GB)

(72) Inventor: Malcolm Rhodes, Heddersfield (GB)

(73) Assignee: RGL INNOVATIONS LIMITED, Leeds (GB)

(21) Appl. No.: 14/352,863

(22) PCT Filed: Oct. 19, 2012
(86) PCT No.: PCT/GB2012/052603

§ 371 Date: Apr. 18, 2014

(30) Foreign Application Priority Data
Oct. 20, 2011 (GB) 1118085.8
Dec. 22, 2011 (GB) 1122126.4

(51) Int. Cl. A61G 5/06; B62B 5/02; B62B 9/20; A61G 5/10

(52) U.S. Cl. CPC A61G 5/06; A61G 5/10; B62B 5/02; B62B 9/20
USPC 280/304.1

(57) ABSTRACT

A device for attaching at least one extension member to an article in use such as a wheelchair, or the like. The device includes at least one clamp means and at least one shoe means where at least part of the shoe means is positioned and/or secured substantially between the clamp means and the article in use, and whereby at least part of the device includes an extension member and/or is adapted to be connected to an extension member in use.

The present invention relates to a device and method of using the same to attach additional members, such as handles or handle extensions, to articles.

Although the following description refers exclusively to such articles being wheelchairs, the skilled person will appreciate that the device could be used with other suitable articles such as sack trolleys and/or the like.

The safe evacuation of people with disabilities, particularly wheelchair users, is currently impossible when evacuating up or down stairs and carrying the evacuee whilst still in his/her own wheelchair is involved. Typically, there is a need for a physical transfer of the wheelchair user from his/her wheelchair into another article or chair. This task falls within the highest risk ranking for any manual handling operation under Health and Safety, Manual Handling Operations Regulations 1992. A comprehensive risk assessment of the manual handling operation has been carried out. This poses serious concerns for the Health and Safety Executive ergonomists who have carried out in depth research in to the problem, but who as yet, do not have a solution. The lowering of a wheelchair down stairs falls in the highest risk category due to the position that must be adopted by the person lowering the wheelchair, as not only does the wheelchair have to be tipped backwards causing the push handles to rotate in a downward arc, but due to the position of the wheelchair on the stairs the operator must be at least two steps behind and therefore two steps above the wheelchair. The result is a stooping position of at least 60 cm whilst attempting to control a very heavy and unstable load, held far away from the body with extended arms. In addition, The Regulatory Reform (Fire Safety Order) 2005 now requires that in an emergency people must be able to be evacuated “away from the building, to a place of safety”. This is not possible with evacuation chairs currently in use to descend stairs as they are not designed for onward evacuation away from the building. Neither is it possible to use evacuation chairs for onward evacuation if the evacuation route is other than level and clear of even small obstructions, as a wheelchair with very small wheels can not traverse uneven or obstacle strewn terrain. The fire risk assessment—supplementary guide for the evacuation of disabled people clearly states that an evacuation plan must be in place that does not require the intervention of the Fire and Rescue Services. This puts the onus of evacuation on untrained personnel, who as employees should not be asked to undertake dangerous manual handling operations.

Currently available equipment i.e. evacuation chairs, rely on the evacuee being able to transfer from his/her own wheelchair into the device with little or no assistance and they are therefore not suitable for the evacuation of people who cannot transfer unaided. For wheelchair users who can not transfer unaided the use of evacuation chairs relies on a dangerous manual handing operation carried out by untrained personnel. This can lead to further injury of the wheelchair user due to unknown medical conditions such as brittle bone disease where serious injury could be caused unwittingly, cerebral palsy where the stress can bring on spasticity of the muscles making a physical transfer impossible, or post polio syndrome where extreme pain can be caused by lifting. Due to other medical conditions many wheelchair users also need a colostomy bag. These problems are acknowledged in the present UK government document Fire Safety Risk Assessment Supplementary Guide: Means of Escape for Disabled People.

It is therefore an aim of the present invention to provide a device that addresses the abovementioned problems.

It is a further aim of the present invention to provide a method of using a device that addresses the abovementioned problems.

It is a yet further aim of the present invention to provide a device and a method of use of the same that enables the safe movement of wheelchairs and users thereof up and/or down stairs and/or other such uneven surfaces in their own chairs.

In a first aspect of the invention there is provided a device for attaching at least one extension member to an article in use, said device including at least one clamp means and at least one shoe means where at least part of the shoe means is positioned and/or secured substantially between the clamp means and the article in use and wherein at least part of the device includes an extension member and/or is adapted to be connected to an extension member in use.

Preferably the article is a wheeled article. Further preferably the article is a wheelchair. Typically the extension member is an extension piece or pole which can be used as a handle extension.

Further typically, the device is attached to the wheelchair handle and/or a portion of the wheelchair adjacent to the same and the extension member extends from the wheelchair in an upward direction.

Preferably the device is attached to and/or substantially adjacent to the handle portion of a wheeled article in use.

Typically at least a portion of the shoe means and/or the clamp means is shaped to conform with and/or follow the shape of at least part of the article to which it is attached in use.

In one embodiment the shoe means includes at least one channel or recess. Typically at least part of the channel or recess is substantially cylindrical and/or semi-cylindrical. Further typically the channel or recess is shaped to receive, abut, correspond and/or otherwise be similar to at least part of a handle, or portion of the article adjacent to a handle portion, to which the device is attached in use.

In one embodiment at least part of the channel or recess is curved and/or follows an arcuate or non-linear path when viewed along the latitudinal axis. Typically the channel or recess is substantially L-shaped. Further typically the channel or recess conforms or substantially follows at least part of the shape of a wheelchair handle stem and/or handle extending therefrom.

In one embodiment the clamp means and shoe means are detachably attached together. In an alternative embodiment the clamp means and shoe means are attached or integrally formed together. Typically the clamp means and shoe means are formed together such that the device is provided as a single unit or unitary body.

Typically when the clamp means and shoe means are detachably attached together the clamp means and/or the shoe means includes a recess and/or socket into which at least part of the other means is received. Further typically the recess or socket is substantially linear to prevent the members from slipping and/or rotating in a direction perpendicular to the axis of the recess or socket.

In one embodiment the clamp means attaches, secures, fastens and/or otherwise fixes the device and/or shoe means to the article in use. Typically the clamp means can be any one or any combination of clamps, shackles, belts, straps, ties, buckles, hook and loop type fastenings, screws, nuts and bolts and/or the like.

In one embodiment the clamp means includes at least two clamp members. Typically the first clamp member is substantially linear and/or planar in shape. Further typically the second clamp member is substantially curved and/or arcuate is shape and/or U-shaped.

In one embodiment at least two clamp members are pivotally and/or hingedly connected together. Typically the ends and/or single edges of two clamp members are connected together. Further typically two clamp members are hingedly and/or pivotally connected together using a knuckle joint and/or the like such that the clamp means can be moved from a closed condition to an open condition and vice versa. For example the clamp can be swung open to the open condition, and/or wrapped around at least part of the article in use in the closed condition.

In one embodiment the clamp means includes at least one fastening means. Typically the fastening means includes any one or any combination of bolts, nuts, screws and/or the like. Further typically the fastening means fixes, closes, secures, abuts, seals and/or otherwise attaches the device and/or clamp means in position.

In one embodiment the one or more fastening means secures the clamp means in a closed condition.

In one embodiment the clamp means includes at least one indentation and/or recess shaped to receive the fastening means. Typically the recess prevents the clamp means form opening even is the fastening means becomes loose or loosens.

In embodiment the clamp means is substantially D shaped. Typically the hinge is formed in a corner of the D. Further typically the fastening means is formed in a corner or the D.

In one embodiment the shoe means conforms with and/or is attached to and/or abuts in use to an upper surface or top portion of a handle and/or article.

In one embodiment the second clamp member conforms with and/or is attached to and/or abuts in use to a lower surface or bottom portion of a handle and/or article. Typically the second attachment member extends and/or wraps around the bottom part of the handle in use.

Further typically the device can be attached and/or retrofitted to an article and/or substantially any manual wheelchair without modification of said chair and/or article.

In one embodiment the device includes at least one attachment means to attach the same to an extension member. Typically the extension member and/or the device includes at least one socket portion by which the same can be engaged and/or attached together.

In one the extension member is substantially linear in shape. Typically the extension member extends from the device. Further typically the extension member extends from the device in a substantially upward direction.

In one embodiment the extension member includes at least one handle portion.

In one embodiment the length of the extension member can be adjusted to a predetermined or selected length. Typically the extension member includes two or more extension portions.

In one embodiment the extension member includes a first and at least a second telescopic portion arranged such that the length of the extension member can be adjusted. Further typically the two or more portions of the extension member are substantially linear.

In one embodiment the extension member includes an elbow portion. Typically the elbow portion includes a bend and/or at least two sections positioned at a non-parallel arrangement such that other extension portions connected thereto can be positioned at an angle and/or non-parallel arrangement in respect of each other. Further typically at least part of the extension member portions are telescopically arranged such that at least part of one portion engages with and/or fits inside another.

In one embodiment in use, two separate devices and/or extension members are connected together using at least one cross-bar member connecting the respective extension members. Typically each device is used on each handle and/or handle bar of the article.

In one embodiment the device includes two pairs of shoe means and clamp means, each pair for connection to separate parts of an article in use. Typically each pair is connected together by at least one cross-bar member.

In one embodiment the cross-bar member is substantially linear in shape. Typically the cross member includes at least two linear portions, such that the length of the cross member can be selected. Further typically the cross-bar member includes first and at least a second telescopic portions.

In a second aspect of the invention there is provided a carrying system for transporting wheeled articles over uneven ground, stairs and/or the like, said system including first and at least a second device, said devices each including at least one clamp means and at least one shoe means where at least part of the shoe means is positioned and/or secured substantially between the clamp means and the article in use and wherein at least part of the device includes an extension member and/or is adapted to be connected to an extension member in use.

Preferably the article is a wheelchair.

In one embodiment the first device is attached to and/or adjacent to a handle portion of the device and at least a second device is attached to a further portion of the frame of the article. Typically the further portion is the chassis and/or a portion of the wheelchair frame adjacent the same.

In one embodiment in use the article has two first devices attached to the handles and two second devices attached to one or more frame members.

Typically the extension member of the device connected to the frame members includes at least one elbow portion.

In a further aspect of the invention there is provided a device for extending and/or providing one or more handles to an article in use, said device including an attachment means and an extension member wherein the attachment means is attached to at least a portion of the article and the extension member extends therefrom in at least one direction.

In a yet further aspect of the invention there is provided a method of transporting or moving one or more articles using a device, said device including at least one clamp means and at least one shoe means where at least part of the shoe means is positioned and/or secured substantially between the clamp means and the article in use and wherein at least part of the device includes an extension member and/or is adapted to be connected to an extension member in use, said method including the steps of;
attaching the device to at least a portion of an article using said clamp means; and
using said extension member to move and/or manoeuvre said article in use.

Specific embodiments of the device and use thereof are now described with reference to the following figures, wherein:

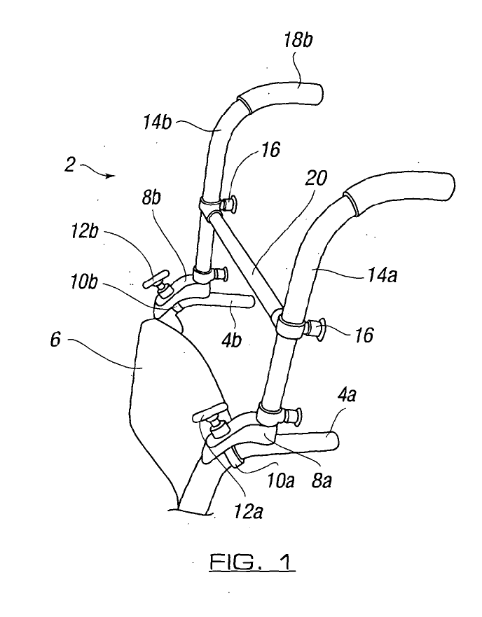

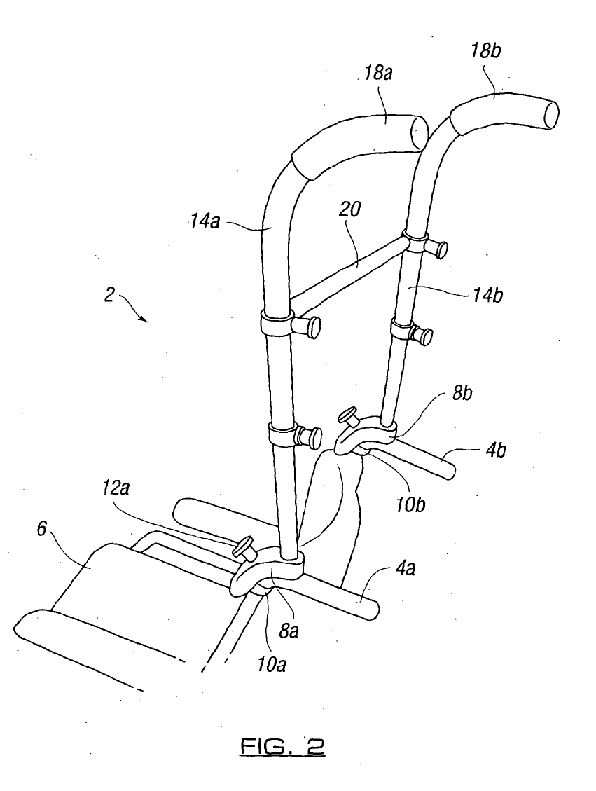

FIGS. 1 and 2 show perspective views of a device in accordance with one aspect of the present invention.

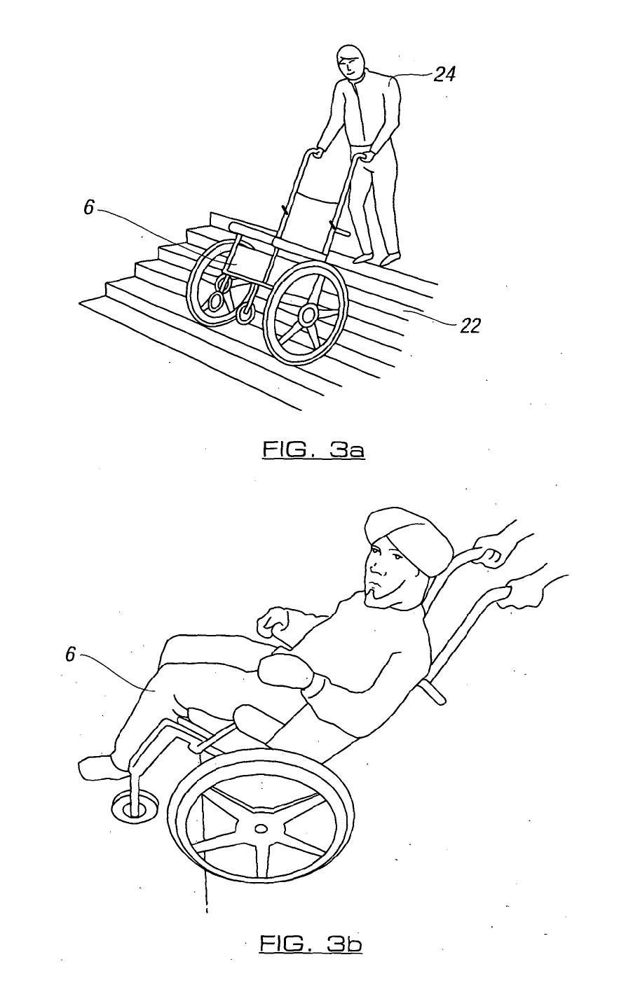

FIGS. 3a and 3b show a perspective views of an embodiment of the device in use;

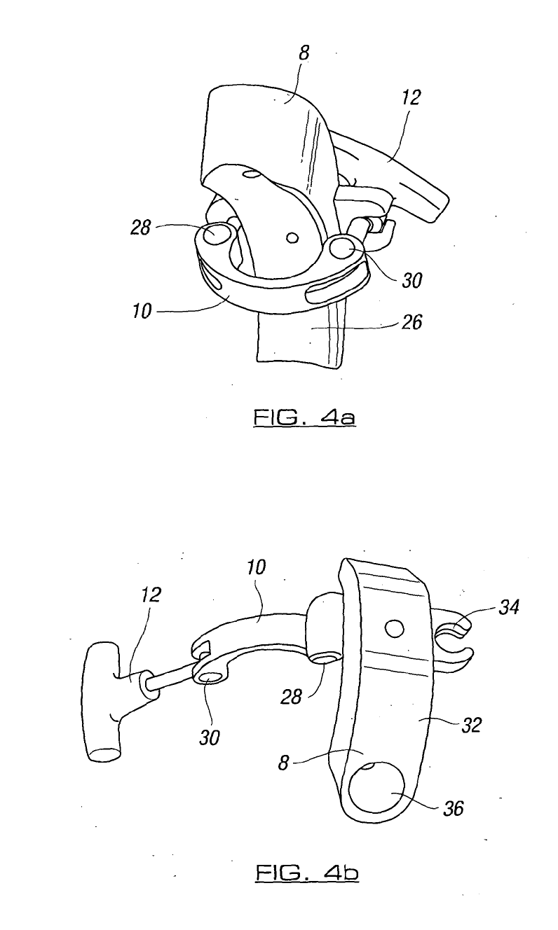

FIGS. 4a-4c show a perspective views of one embodiment of the shoe and clamp means; and

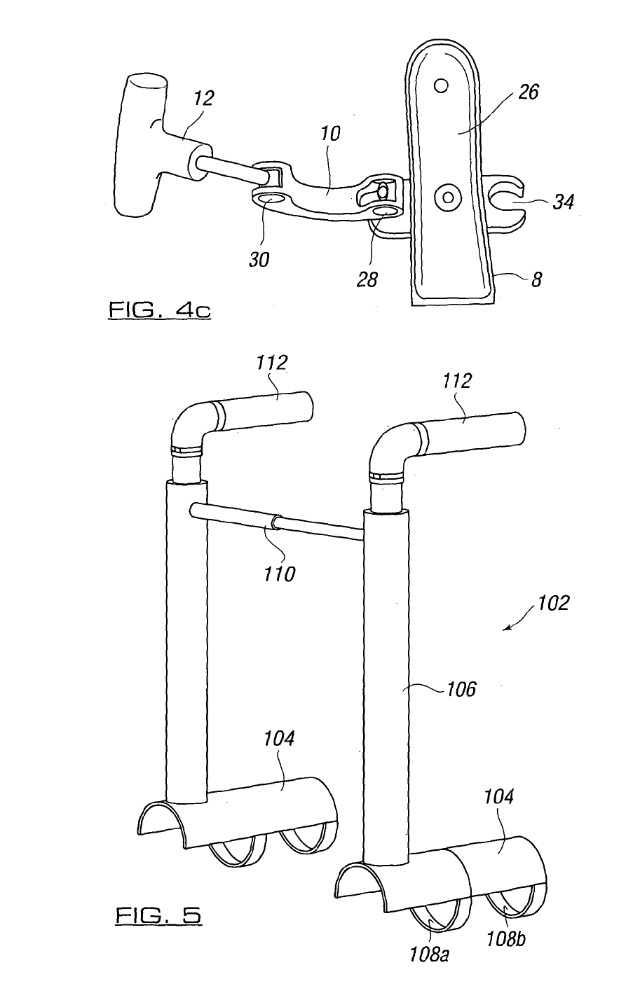

FIG. 5 shows a further embodiment of the device.

To overcome the current state of affairs with regard to wheelchair evacuation, the present invention facilitates the conversion of a person's own wheelchair, extemporaneously; without any adaption of the chair required, into a safe and stable evacuation chair thereby eliminating the need for a physical transfer of the evacuee from one device to another and the need to physically carry the wheelchair down or up stairs thus eliminating the need for dangerous manual handling operations.

Further benefits of a wheelchair user being able to remain in their own wheelchair are;
Many wheelchairs are adapted for the needs of the users with supports for various parts of the body. This is particularly important where a person needs support for the upper body for stability.
The wheelchair, if abandoned up the stairs, becomes a hazard in the evacuation route for other evacuees and for first responders entering the building.
The wheelchair, if abandoned up stairs is not available for the safe onward evacuation of the evacuee.

Turning to FIG. 1 where there is shown one embodiment of a device 2 attached to the handles 4a, 4b of a wheelchair 6. The device comprises a pair of shoes 8a, 8b which are substantially L shaped and which abut and sit on top of the handles 4a, 4b in use. The shoes 8a, 8b are secured in position using adjustable clamps or shackles 10a, 10b that extend or wrap around the handles 4a, 4b. The clamps can be adjusted by tightening or loosening the T-bolts 12a, 12b.

Extending from the shoes 8a, 8b are the extension members or bars 14a, 14b. The extension members are telescopic and therefore the length of the same can be selected and adjusted accordingly. Pins or bolts 16 hold the members in position once the length of the same has been selected. FIG. 2 shows a rear view of the device 2 where the extension members 14a, 14b have been lengthened or extended. This is a particularly useful feature as the members can be adjusted such that people of different heights can assist in moving the wheelchair without having to bend and place strain on their backs.

The extension members also include handle portions 18a, 18b by which the device 2 and therefore the wheelchair 6 can be gripped and manoeuvred. The extension members 14a, 14b are connected by a substantially horizontal cross-bar 20 which provides additional stability to the device.

FIGS. 3a and 3b shows the device is used to assist in moving wheelchairs and their occupants particularly up and down stairs 22. This is achieved by the device providing leverage to turn or tilt the chair back slightly onto its rear wheels. FIG. 3a shows how an operator 24 assisting a wheelchair user is ideally ergonomically positioned to assist in moving the chair over uneven terrain and is not placing undue stress on their body. The telescopic extension members ensure that the device can be adjusted to suit any height of operator. In use the chair and user can be lowered down the stairs or raised up the same safely and in a controlled manner. Using the extended handles of the device it is possible to tip the wheelchair to a position of balance over the axle of the rear wheels thereby transferring the downward force to the rear wheels that remain in contact with the ground or stair at all times. The operator assisting the wheelchair user is stable with a straight back, arms close to his body and at waist height. He is two or three steps behind the wheelchair. The same position can be used to move the chair over gravel or cobble stones and thus prevent the smaller front wheels from digging in and/or becoming stuck.

It is envisaged that the device can be quickly attached and detached from the chairs without modifying the same or having any loose parts or fittings to deal with. Therefore the device can be stored near staircases and/or with other evacuation equipment until it is required for use.

FIGS. 4a-4c show the configuration of the clamp 10 and the shoe 8 used in this embodiment to secure the extension members to a wheelchair. Although it is wheelchair handles that are the articles to which the device is attached, the person skilled in the art will appreciate that the device could be used to attach extension members to other parts of a wheelchair, or indeed other articles entirely, such as sack trolleys and/or the like, usually be altering the shape and/or profile of the shoe 8.

FIG. 4a shows an embodiment wherein the shoe 8 is substantially L-shaped with a semi-circular groove or recess formed in the inside face 26. This L shape and the recess conforms at least in part to the tubular frame and shape of the handle portions of a wheelchair. Although the shoe 8 may not perfectly fit or conform to the shape of the wheelchair handles, the shape is such that there is a minimum of two points of contact between the shoe and the wheelchair at all times of operation. As such, the device is very stably mounted to the chair in use. The clamp 10 in this example includes a hinge portions 28 and 30. The T-bolt 12 screws into and is engaged in the hinge portion 30 such that the clamp and therefore the device can be attached and firmly fixed to the chair handle or portion of the chair adjacent to the handle.

FIG. 4b shows the outer face 32 of the shoe 8 where the clamp 10 has been opened entirely. This is achieved by at least partially unscrewing the T-bolt 12 to an extent that the T-bolt head can be lifted from the socket or recess 34 formed in the clamp to receive the same. A second socket or recess 36 is formed in the shoe 8 to receive an extension member 14. FIG. 4c shows the inside face 26 of the clamp 10 also in the open configuration. Although in the present example the shoe 8 and clamp 10 are shown attached together, the skilled person will appreciate in an alternative embodiment the shoe 8 and clamp could be detachably attached together and provided as separate items.

Turning to FIG. 5 where there is shown a further embodiment of a device 102, said device is constructed from strong aluminium tubes welded together substantially in the shape on an “L” where the horizontal tube 104 is slid over the push handle of the wheelchair with the telescopic vertical tube 106 to the front. The horizontal tube 104 is cut to form a half tube fitting on top of the push handles which has hook and loop material glued to the upper surface of the tube. Two strong rings 108a, 108b are left in place on the tube for added security the forward ring being placed so that the handle can take into account any braking mechanism fitted to the underside of the wheelchair handle. The vertical tubes 106 are telescopic allowing for adjustment of height to four positions with the use of spring buttons. The weld joining horizontal tube 104 and vertical tube 106 is strengthened by a triangular plate 9 welded to both tubes. Two devices are fitted to the wheelchair, one for each handle, each designed to fit either the left or right handle each handle having one part of a horizontal telescopic tube 110 attached close to the top of the bottom section of the vertical telescopic tube 106. One side handle having the male tube and the other side handle having the female tube. When fitted together and locked in position this tube forms a very strong stabilising bar.

The device is secured to the wheelchair handle (not shown) in a vertical position by sliding the horizontal tube 104 over the wheelchair push handles then securing in place with double sided hook and loop tape joined to the hook and loop material 108 secured around the top half of the horizontal tube 104. The double sided hook and loop tape is then put under tension as it is wrapped around the wheelchair push handle prior to wrapping again round the handles thus creating a very strong binding of the device to the wheelchair.

The telescopic stabilising bar 110 and telescopic operating handles 112 allow for adjustment to both height and width of the device ensuring that one design will fit most standard wheelchairs.

The telescopic tubes are kept in place with the use of spring buttons.

With the push handle tubes engaged and the operating handles of the device extended a very efficient second class lever is created allowing easy and safe backwards tipping of the wheelchair to a point of balance with the need for bending and stooping of the operator totally eliminated.

When used to negotiate stairs, the angle of the descent is not important as the device is always stable and a significant amount of the load is born by the stairs. The angle of the device handle to the horizontal will have a slight effect on the force absorbed by the stairs. This means the device can be controlled by one person descending stairs in an emergency. However it is recommended that a second person assists by pushing the wheelchair back against the stair for additional stability. Wheelchair users who propel themselves can also assist by braking the large wheels during the descent.

The device has been designed to aid the safe and effective evacuation of wheelchair users by allowing them to remain in their own wheelchair, however many other applications are possible for the device. For example:
Personal use in non evacuation situations; When used with the operating handles in the down position this raises the height of the normal pushing position. Without the use of the device a person is always stooping forward when pushing. When pushing for extended periods i.e. shopping trips, this is very uncomfortable for the pusher.
Where short flights of steps are encountered these can easily be overcome. This will be particularly useful in listed (protected) buildings.

There are many examples of where, with the best of intentions, ramps have been installed to aid wheelchair users but unfortunately can not be used due to the severe gradient of even short ramps. This device overcomes this problem.

Many buildings with short flights of steps fit wheelchair stair lifts. These are dangerous to other people when deployed as they block any escape route. The use of such lifts can be eliminated and buildings made safer for all.

The device will open up more recreational activities to wheelchair users for by being capable of allowing the wheelchair to be tipped backwards onto the large diameter rear wheels uneven surfaces such as cobble stones in ancient buildings, gravel car parks, grassed areas, rural tracks and pathways can be traversed with ease. The fact that the pusher does not have to stoop means the operation is totally safe. Many English Heritage and National Trust properties will benefit from this device in addition to national parks and other outdoor recreation facilities.

Consideration is also being given to the creation of a new sport in which the wheelchair user and a partner can take part in competitive races involving obstacles such as steps, logs, large rocks see saws and other challenges. This would be combined with skills such as shooting, archery, basketball shots etc. It is also intended that the sport will involve a strategy component in order that the two person team have to work well together for a successful outcome. It is also envisaged this could be a team sport, particularly where serious strategies can be incorporated

The device could also be attached to standard sack carts for use with heavy loads thereby reducing the risk of injury from tipping the heavy load with short handles.

With reference to FIG. 5, in this embodiment there are two separate devices that are attached to the rear of the wheelchair frame by being securely fastened to the two push handles independently.

The device is for safely evacuating wheelchair users, up or down stairs, in their own wheelchair thereby eliminating the dangers involved with either a carry down procedure or the need for a physical transfer from a wheelchair into an evacuation chair. Constructed from aluminium tubes welded in the shape of “L” with the horizontal tubes having cut outs. The vertical tube 106 is welded to the front of the horizontal tube 104 to form a second class lever for operation. The device is secured to the wheelchair handles using hook and loop tape or similar such means around the horizontal tube 104 and the exposed wheelchair handle at cut out. Vertical tubes 106 are telescopic secured in different positions with spring buttons engaging holes in tube. The horizontal tube 104 fits over the existing push handles of the wheelchair. Telescopic vertical operating handles 112 attached to the front of horizontal tube 104 form a very efficient second class lever for the operation of the device. The horizontal tube 104 has two cut away sections removed to create a section of half tube and to leave two sections of strong circular tube for added security and safety. The tube shoe 104 fits easily over existing wheelchair handle grips however these do vary in diameter. To make this device secure and universal the area on top of the half tube is covered with the loop material of hook and loop fastening tape 108. The hook side of a strip of double sided hook and loop tape is then secured to the loop material fixed to the half tube and wrapped around the wheelchair push handle exposed by the cut away section in the horizontal tube 104. The loop material fixed to the half tube 104 provides a very strong bond when the hook side of the double sided material is attached thereby creating very secure purchase for applying tension to the double sided hook and loop tape when securing the device tightly to the wheelchair handle. The hook and loop material has a surface area of approximately four square inches attached to the half tube 104. Hook and loop will support a load of 75 kg with a surface area of two square inches.

We can therefore support a load of approximately 150 kg by using this amount of material. The one sided tape having been passed under the wheelchair push handle is then wrapped around the handle again creating an additional surface area of approximately eight square inches which will support an additional 300 kg on each independent part of the device.

When secured to the wheelchair handles the devices are stabilized with the use of a telescopic tube 110 attached near the top of the lower section of each of the operating handle tubes 106. The male section of the stabilizing bar is attached to one of the devices with the female section being attached to the other at right angles to the horizontal bar 104 with each section extending towards the other. The stabilizing bar can be locked in position with the use of a simple thumb screw attached to the outer tube that operates by extending the screw through a hole in the outer tube to make contact with the inner tube applying sufficient force to lock the inner tube to the outer tube thus making the device infinitely adjustable in width.

The top of the upper section of the vertical operating handles 112 is bent at an angle of 90 degrees to provide a very secure grip. The height of the operating handles is adjustable enabling the upper section of vertical tube drawn upwards. It is secured with the use of spring buttons in the inside the upper section of the operating handle 112 and holes in the lower section of the operating handle to take the spring buttons. The operating handles can be adjusted to four predetermined heights designed to provide a comfortable position for the operator.

When the operating handles 112 are extended, the device can be used to safely tip the wheelchair and user back on to the large rear wheels to a point of balance. In this position it is a simple and efficient task to transport the wheelchair and user over difficult and uneven terrain. Because the rear wheels of a wheelchair have a large diameter the wheelchair can negotiate uneven surfaces without difficulty. In the tipped position the wheelchair can be safely lowered down stairs. The extended operating handles of the device 2 allow the person lowering the wheelchair to maintain a stable comfortable position with a straight back and the load held close to his/her body.

### Advantages

The invention solves the problem of evacuation of wheelchair users by:
Dramatically reducing the risk of injury to the persons carrying out the evacuation during a manual handling operation of either physically carrying the wheelchair or by lowering the wheelchair down the stairs with the person lowering the wheelchair in a very unstable and very uncomfortable position.
Eliminates the necessity for a team handling operation when carrying a wheelchair which has more difficult challenges due to the number of people involved.
Dramatically reduces the risk of injury to the evacuee caused by the person lowering the wheelchair down the stairs being compelled to adapt a very unstable and dangerous position for the manual handling operation they are performing, a position from which the inventor has personally fallen down stairs whilst assisting a wheelchair user down stairs.
Enables the person lowering the wheelchair to have a clear unobstructed view of the stairs he/she is about to tread on.
Dramatically reducing the danger faced by the person being evacuated as a physical transfer from one device to another which causes stress and can result in seizure activity, spasticity and severe pain, is eliminated.
Enables the evacuation to a place of safety away from the building as now required by law. This is not possible using currently available equipment as these pieces of equipment are all designed specifically to travel down stairs. Some then rely on small wheels for horizontal evacuation. This is not possible unless the route is level and obstacle free.
Having the capability of evacuating persons up stairs in addition to down stairs by virtue of the fact that the person raising the wheelchair is stable and comfortable with a straight back and the load kept close to the body. This is particularly useful in underground situations such as transport systems and mines and basements of department stores etc. It is recommended this exercise is a two person operation.
Enabling the evacuee to remain in his/her own wheelchair is particularly important as a person's wheelchair is often custom made to provide the supports necessary. This is particularly important for casualties who do not have full control of their bodies, particularly upper body strength.
The wheelchair is not abandoned up the stairs and is available for onward evacuation to a place of safety, even under difficult conditions.
The wheelchair is not abandoned therefore does not cause an obstruction in the evacuation route for other evacuees, nor does if form an obstacle for fire and rescue personnel entering the building.
Reduces the numbers of people needed in the evacuation of a single casualty. Current government advice states it could take up to four trained people to carry down a wheelchair. The maximum number required to operate this device is two but it can be operated by one person under pre-determined conditions.
Eliminating the need for a manual handling risk assessment every time a carry down is contemplated other than by exempt persons thereby saving a huge amount of time waiting for the assessment to be carried out once the evacuation has been ordered.
The use of this device allows building managers and employers to comply with current legislation.
Providing a workable and practical solution to the anomalies of current government advice which is to say the least ill conceived.
The invention requires minimal training for operators and evacuees.
As the devices are small compact and light weight several of the devices can be stored at the point of need, multiple devices are immediately available for use in an evacuation thus eliminating the need for re-entry to the building.

Currently there is no safe and effective method of evacuating wheelchair users who can not transfer from their wheelchair unaided. Current government advice is inappropriate and can place both the evacuee and the helpers in serious danger. The manual handling of a wheelchair, without the use of this device, down stairs is in the highest risk category for the following reasons:
Wheelchairs are designed to roll on flat surfaces. They are not designed to be carried.
Parts easily detach from wheelchairs, i.e. wheels, arm rests, foot plates, back rests and stabilisers without the need for tools thereby creating unsafe lifting holds for unskilled persons.
Once vulnerable lifting holds are removed there are few secure holds readily available
Wheelchairs are designed to fold, this is dangerous during a carry down as the wheelchair is unstable and creates a serious risk to the persons carrying due to a sudden shift in load position. The use of this device eliminates that risk as the wheelchair remains on the ground in a stable position. The weight of the wheelchair user ensuring stability of the wheelchair.
The weight of the person to be carried can be extremely high (often in excess of 200 lb's) making a carry down physically impossible.
As each carry down is a high risk manual handling operation, a full manual handling risk assessment must currently be carried out each time such a carry down is contemplated prior to the task being undertaken. This will show the task can not be carried out safely.

This invention eliminates these dangers and allows current government advice to be followed without putting anyone in more danger than they are already in due to the evacuation.

1. A device for attaching at least one extension member to a wheelchair in use, said device comprising:
at least one clamp means;
at least one shoe means where at least part of the shoe means is positioned substantially between the clamp means and the wheelchair in use; and
at least part of the device includes an extension member or is adapted to be connected to an extension member,
at least a portion of the shoe means including a channel that conforms or substantially follows at least part of the shape of a wheelchair handle stem and/or handle extending therefrom in use, the channel having a curved or non-linear path when viewed along a latitudinal axis.

2-5. (canceled)

6. A device according to claim 1 wherein the channel or recess is substantially L-shaped when viewed along the latitudinal axis.

7. A device according to claim 1 wherein the clamp and shoe means are formed as a single unit.

8. A device according to claim 1 wherein the clamp means is any one or any combination of belts, straps, ties, buckles, hook and loop type fastenings, screws, nuts and bolts and/or the like.

9. A device according to claim 1 wherein the clamp means includes at least two clamp members.

10. A device according to claim 9 wherein the first clamp member is pivotally or hingedly connected to at least the second clamp member.

11. A device according to claim 9 wherein the clamp means is substantially D-shaped.

12. A device according to claim 10 wherein the second attachment member conforms with a lower surface or bottom portion of a handle in use.

13. A device according to claim 10 wherein the first and at least second attachment members engage and/or connect together using a fastening means thereby securing the device to the wheelchair.

14. A device according to claim 1 wherein the extension member is detachably attached to the device.

15. A device according to claim 1 wherein the extension member includes at least one handle portion.

16. A device according to claim 15 wherein the extension member includes a first and at least a second telescopic portion arranged such that a length of the extension member can be adjusted.

17. A device according to claim 10 wherein the extension member includes an elbow portion.

18-20. (canceled)

21. A system for transporting wheelchairs over uneven ground, stairs and/or the like, said system comprising:
first and second devices, attachable to at least part of the shape of a wheelchair handle stem and/or handle extending therefrom, said devices each including at least one clamp means and at least one shoe means where at least part of the shoe means is positioned substantially between the clamp means and the article in use and at least part of the device includes an extension member and/or is adapted to be connected to an extension member, at least a portion of the shoe means including a channel that conforms or substantially follows at least part of the shape of a wheelchair handle stem and/or handle extending therefrom in use, wherein said channel has a curved or non-linear path when viewed along the latitudinal axis.

22. A method of transporting or moving one or more articles using a device, said device including at least one clamp means and at least one shoe means where at least part of the shoe means is positioned substantially between the clamp means and the article in use and wherein at least part of the device includes an extension member or is adapted to be connected to an extension member in use, at least a portion of the shoe means including a channel that conforms or substantially follows at least part of the shape of an article, wherein said channel has a curved or non-linear path when viewed along the latitudinal axis, said method including the steps of;
locating at least part of said article in the channel;
attaching the device to at least a portion of an article using said clamp means; and
using said extension member to move and/or manoeuvre said article.
